(19) United States
(12) Patent Application Publication
(10) Pub. No.: US 2012/0311506 A1
(43) Pub. Date: Dec. 6, 2012

(54) Selector

(76) Inventors: Ilpo Kojo, Helsinki (FI); Kristian Lukander, Espoo (FI)

(21) Appl. No.: 13/481,897

(22) Filed: May 28, 2012

Related U.S. Application Data
(63) Continuation of application No. 11/815,746, filed on Dec. 13, 2007.

(30) Foreign Application Priority Data
Feb. 7, 2005 (FI) 20055054

(51) Int. Cl. G06F 3/048

(52) U.S. Cl. 715/857

(57) ABSTRACT

Sectors including selection elements are scaled (405) according to the location of a selector pointer so that a selector comprising several selector elements can also be implemented on a small screen and that the selection element is sufficiently large before selection.

### FIELD OF THE INVENTION

The invention relates to an electronic device which comprises a graphic user interface, and particularly to a selector for a graphic user interface which is used by a control means and its pointer.

### BACKGROUND OF THE INVENTION

In nearly all electronic devices, a display is used as the graphic user interface, which the user may employ to make different selections through a control means, for example control the device. For use of the device, various selection elements, such as icons, are typically shown on the display and a desired element is then selected by the pointer of the control means. Several functions can be used by selecting suitable alternatives from menus and by activating a desired function or setting. The use of some applications requires typing in of text, which may also be performed by means of the selection elements of the graphic user interface. Depending on the type of the graphic user interface, the control means may be based on touching the user interface screen (known as a touch screen where the control means usually recognizes a pointer, i.e. movements or strokes by either the user's finger or a small writing means, i.e. a stylus, such as a small pen-like object) or on a control means employing a cursor that moves on the screen or the like, such as a joystick, mouse, keyboard or a similar controller, such as various game controllers.

More and more devices are designed to be movable from one place to another, in which case the size of the device should be as small as possible. In a small device, the screen is substantially small even though it were nearly as large as the actual device. The small size of the screen and simultaneous display of several selection elements on the screen usually results in that the elements to be displayed on the screen are substantially small and thus difficult to select. The problem is emphasized in a device which should allow typing in of text. The typing in of text and/or numbers requires several selection elements on the screen, which require a relatively large screen to be easily readable and selectable by the user.

### BRIEF DESCRIPTION OF THE INVENTION

The object of the invention is to provide a method and an apparatus implementing the method so that even a small-sized screen can be provided with a sufficient number of selection elements and the element to be selected is sufficiently large in a selection situation. The object of the invention is achieved by a method, computer software product and device which are characterized by what is disclosed in the independent claims. Preferred embodiments of the invention are disclosed in the dependent claims.

The invention is based on placing selection elements in scalable sectors and changing the size of the sectors, and thus preferably also the size of the selection elements, as the pointer of a control means changes its position on the screen.

An advantage of the invention is that it enables placement of several selection elements on a very small screen so that the sector with its elements pointed by a pointer is sufficiently large, having, for example, a readable size, which enables noticing and correcting an error before the actual selection is made. Thus it allows minimization of the device size without compromising user friendliness.

### BRIEF DESCRIPTION OF THE FIGURES

The invention will now be described in greater detail by means of preferred embodiments with reference to the accompanying drawings, in which

FIG. 1 is a block diagram illustrating a device where the invention is applicable;

FIGS. 2A to 2G illustrate examples of what a selector may look like in an idle mode;

FIGS. 3A, 3B and 3C illustrate examples of a selector in a selection mode;

FIG. 4 is a flow chart illustrating operation according to an embodiment of the invention; and

FIG. 5 is a pseudo code of a scaling algorithm.

### DESCRIPTION OF EMBODIMENTS

In the following, the invention will be described by means of an exemplary device without limiting the invention to a device implemented this way. Devices, different programming techniques and methods of implementing graphic user interfaces are constantly developing. This may require additional changes to the invention. For this reason, all words and expressions should be interpreted broadly, being intended to be only illustrative of the invention without restricting it.

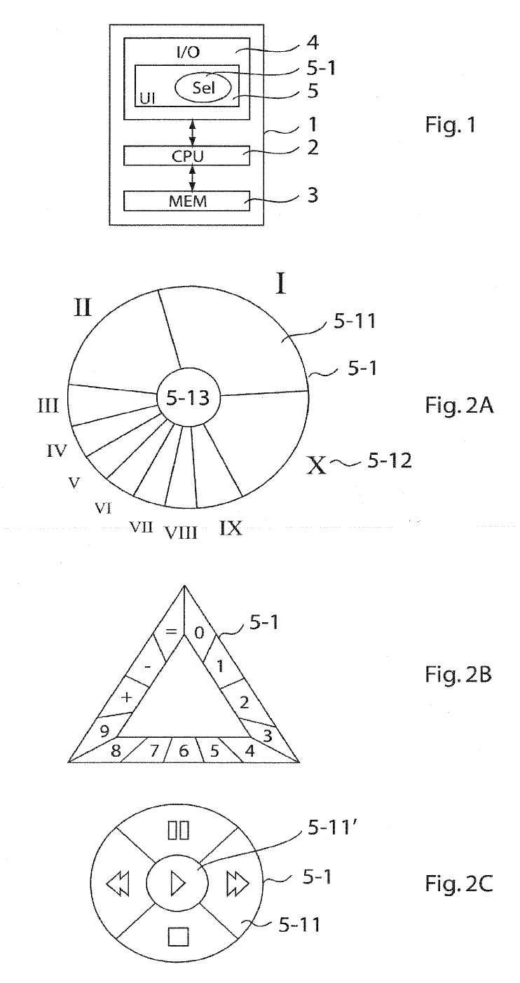

FIG. 1 is a simplified block diagram illustrating a device comprising a graphic user interface, i.e. a display. A more detailed structure of the device is irrelevant to the actual invention and need thus not be described more closely here. It will be obvious to a person skilled in the art that the dew vice may also comprise other functions and structures. The device may be any device provided with a graphic user interface. Examples of different devices where the invention is applicable include PDA devices (personal digital assistant), palmtops, conventional computers, various mobile communication devices and phones, various portable players, such as MP3 players or DVD/CD players, game consoles, laboratory devices, terminals used in places where good hygiene is required, for example in operating rooms, and corresponding meters, Internet kiosks, ticket machines, automated teller machines, etc.

The device 1 according to the example of FIG. 1 comprises a central processing unit 2 (CPU), memory 3 (MEM) and I/O (input/output) system 4. All the necessary data are stored in the device's memory 3. The memory 3 may comprise a read-only storage portion, which may consist of ROM memory, for example, and a writing storage portion, which may consist of RAM (random access memory) memory and/or FLASH memory. Using the I/O system 4, the device communicates with the user and other devices and/or the network, for example, depending on the device. A user interface 5, which is part of the I/O system 4, comprises a necessary interface for communicating with the user, such as a graphic user interface, i.e. a display 5 with a control means, an optional pointer (a separate control means with a pointer is not shown in the figure) and a selector 5-1 according to the invention. The interface may further include a keyboard, loudspeaker and/or microphone. Depending on the type of the device, there may be different user interface components and their number may vary. The data received from the different device components are transmitted to the central processing unit (CPU), which processes the received data in a desired manner, i.e. performs functions according to different embodiments of the invention.

The invention is applicable in substantially all types of displays, the type of the display used being irrelevant to the implementation of the invention. The device's display may be, for example, a touch screen or a screen utilizing cursor-based selection. The control means as well as its pointer (both of which are not shown in the figure) are dependent on the display type and may be any kind of combination of a control means and a pointer according to prior art or a combination of several control means and/or a pointer for pointing a desired object on a graphic screen and selecting the object, if desired. The control means may thus be a touch screen or a touch-sensitive panel, for example, where the user's finger or a separate stylus functions as the pointer; a roll mouse, a track stick, a navigation controller (for example a five-direction navigation controller), a part of a keyboard, such as certain keys, a selection bar, a jog dial or a joystick having a cursor visible on the screen as its pointer, for instance. The control means and pointers listed above are only examples of control means and pointers, which do not restrict the invention. The control means may also be another kind of control means, such as a future control means. The operation of the control means and its interaction with the display through the pointer are well known to a person skilled in the art and irrelevant to the actual invention. For this reason, its operating principles will not be discussed here in greater detail.

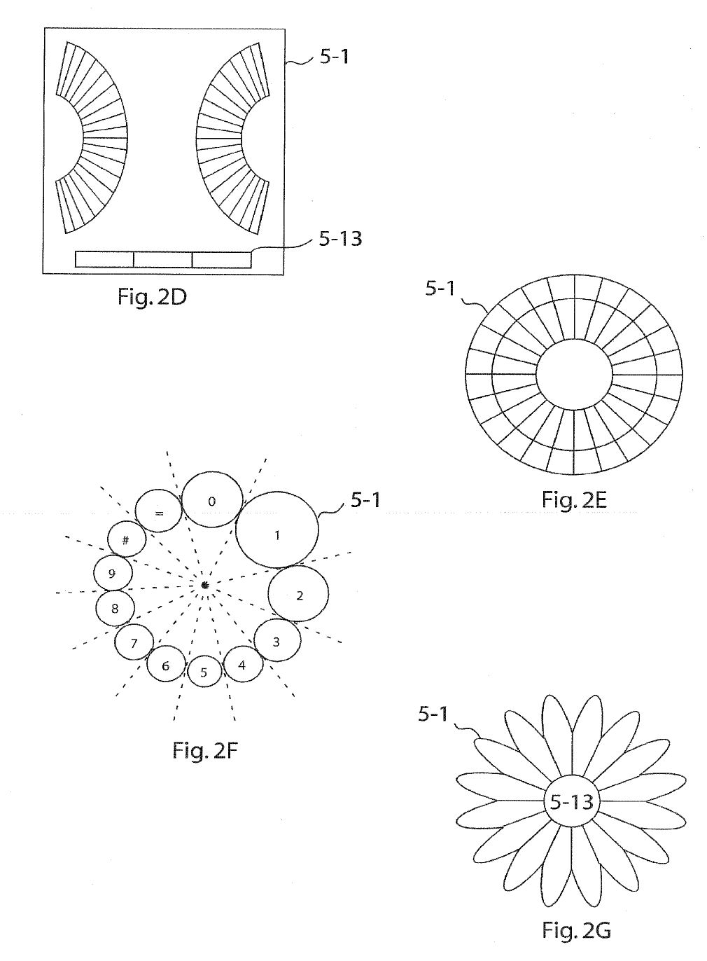

The user interface 5 comprises a selector 5-1, which includes one or more sectors or sector parts. FIGS. 2A to 2G illustrate examples of different selectors 5-1. The selector 5-1 may be hidable from the screen or configured to be hidden when not used, or the selector may remain on the screen all the time. The selector 5-1 may cover the whole screen area or only part of it. The selector 5-1 may also be partly or totally transparent so that the text beneath it is readable or does not interfere, for example, with videoing, but it may also be completely non-transparent.

FIGS. 2A to 2G illustrate different examples of selectors. At its simplest, a selector according to the invention comprises at least one sector or sector part provided with a selection element, the sector or sector part being scalable with respect to the other sectors or sector parts. The sector 5-11 refers to any-shaped selector sub-area or block. Preferably, a central angle is determinable for the selector. The selector 5-1 is preferably a part based on the circumferential shape of a geometric pattern (for example, a square, rectangle, circle, triangle, ellipsis, semi-circle, rhombus, hexagon), such as a corresponding circumference or circumference part which has been divided into sectors so that each selection element 5-12, such as alphabets and numerals, has a sector of its own, each sector is scalable, and most sectors have the same centre. In other words, the selector or part of it can be divided into the number of sectors 5-11 required by the need and use, regardless of the selector shape. The circumferential structure provides the advantage that the number of selection movements needed to select a single selection element can be minimized but the selector does not need to be circumferential. A further advantage of the circumferential structure is that all sectors can be kept relatively in the middle of the central vision area of a human, i.e. in the middle of the field of vision (when a person fixes his eye on the selector). In that case, the sectors remain in the area of accurate vision and the selector is optimized in view of sight. The fact that the selector sectors stay in a desired scaling area even when scaled is achieved in the invention by determining one or more attributes, i.e. limit values, related to the size or shape, such as the maximum circumference length, the sum of the angles of the sectors or some sectors with respect to a certain centre, the maximum diameter or radius of the selector, the maximum length, width or surface area of the selector. Other limit values may also be defined for the selector, such as the minimum length, minimum diameter, etc., for determining the selector size and the surface area it needs on the screen. The limit value or limit values are used to determine the scaling area when the selector is scaled.

The fact that the sectors that are scaled with each other have a common centre provides the advantage that the scaling algorithm is kept simple. A simple algorithm is easy to implement, it does not require a lot of memory or a large computing capacity, and thus it sets no considerable requirements for the computing capacity of the device.

The fact that each selection element has a scalable sector of its own provides the advantage that the selection becomes easier; for example, it is not that dependent on accurate focusing of the control means and no solution is needed for the problem of how to perform selection between different symbols in the same sector. Thanks to scalability, the size of the selector sectors does not in any way limit the number of selection elements in the selector because, in the idle mode, the size of the selection elements is not that important, and in the selection mode, sectors are scaled according to the pointer location, i.e. according to a possible selection so that the sector that may be selected is large enough for selection.

The selection element 5-12 refers to any selectable element or object, such as a single letter, number, figure, or an icon which is pointed at to start and process a corresponding application, file or program. The selection element may also be a menu or part of a menu. The selection element may also be a constituent of a document, such as the line/number of a text passage. In other words, the structure of a document can be shown by means of the selector, and one may move in the document utilizing the selector. It is not relevant to the invention what are used as the selection elements and how they are located in the sector. The order of selection elements can be modified according to the user's preferences. They may be placed according to the occurrence frequency, in the order of magnitude, in the alphabetical order, etc.

The selector may also comprise a part or parts 5-13 which are not divided into sectors or a sector, as illustrated in FIGS. 2A, 2D and 2G. Depending on the implementation, the user may give values to the different radii of the selectors according to FIGS. 2A and 2D and thus also adjust the size of the selector shown on the screen. FIG. 2A illustrates the selector in the selection mode when the pointer is in section 5-11 for I, the sectors having an equal size in the idle mode. The example of FIG. 2D also illustrates that the selector sectors can be placed on two or more different circumferences which need not have the same shape (as is the case in FIG. 2D). FIG. 2D further illustrates that the selector may also comprise only part of a circumference even though it has a circumferential shape. The selector may also comprise sectors separate from the other sectors (not shown in the figures), which may or may not be scaled. The separate sector may be, for example, an image of a telephone receiver. The selector may also comprise embedded selection circumferences, for example as illustrated in FIG. 2E, or the selection circumference may be divided into sub-circumferences. Neither need the sectors be of the same size or even of the same shape. This is illustrated in FIG. 2C, where sector 5-11 is larger than sector 5-11′ and has a different shape.

The sector size may be determined on the basis of the probability at which a selection element in a sector is selected, for instance. This is illustrated in FIG. 2F. FIG. 2F also illustrates how the selector can be divided into sectors having a common centre even though the selection elements visible on the screen do not indicate this in any way. The sectors illustrated by broken lines in FIG. 2F are not visible in the actual selector and thus not on the screen.

FIG. 2G shows that the invention does not in any way limit the design of the selector appearance but it may be tailored according to the graphic theme, for instance.

The selector may also comprise any number of mode switches 5-14, which switches the mode between the objects to be selected. For example, a switch can change capitals into lower-scale letters or vice versa. Instead of a separate mode switch, the mode can be selected according to the direction where selection starts. For example, the mode of the sectors in FIG. 2G may be “lower-case letters” when selection starts from outside the circumference and “capital letters” when selection starts from the middle of the circle, i.e. from inside the circumference.

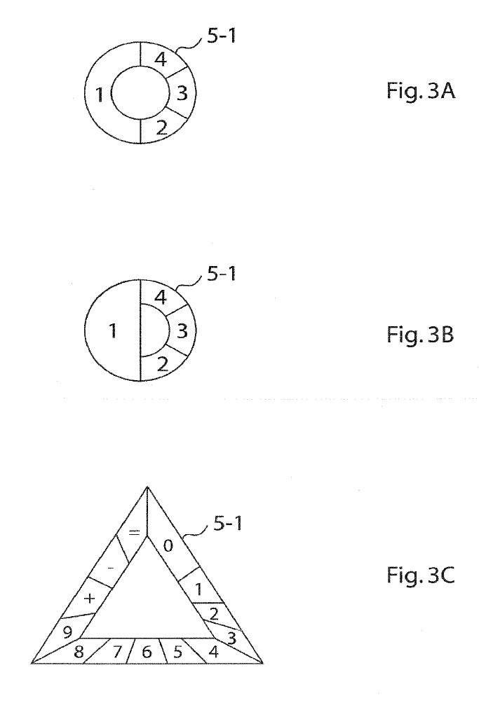

FIGS. 3A and 3B illustrate the influence of the limit value described above in scaling by showing the selector of FIG. 2A in a selection mode according to two different embodiments. FIG. 3C illustrates the selector of FIG. 2B in the selection mode. In the examples shown in FIGS. 3A and 3B, it is assumed that all sectors are scaled. In FIG. 3C, only some of the sectors are scaled. In other words, the scaling rules for the selectors shown in the figures are different. It is also feasible that some of the sectors are scaled to such an extent that it seems that they are hidden under the sector being scaled. In an embodiment according to the invention, the selector may be configured to hide the selection element in response to the fact that the sector decreases below a preset limit value.

In FIGS. 3A and 3B, the user intends to select number 1 and has moved the control means/pointer to the sector of number 1, which has thus increased. In the example of FIG. 3A, the selector surface area remains constant and the sectors are scaled so that sectors that have not been selected decrease in size in the same proportion with respect to each other. In the example of FIG. 3B, the selector surface area is not constant but it increases in selection; however, the length of the outer circumference of the selector remains constant. Also in the example of FIG. 3B, other sectors have been scaled so that they are equally small. In the example of FIG. 3C, the user intends to select number 0 and has moved the control means/pointer towards sector 0, which has thus increased. Also in the example of FIG. 3C, the selector area remains constant but only some of the sectors, i.e. the sectors limited to the same inner side of a triangle, are scaled so that the sectors that have not been selected decrease in the same proportion with respect to each other, while the size of the other sectors remains constant.

It should be emphasized that the purpose of FIGS. 3A, 3B and 3C is to only illustrate the influence of different limit values (attributes) and scaling rules. It will be obvious to a person skilled in the art that various limit values and scaling rules exist that may be used even though they have not been described in greater detail.

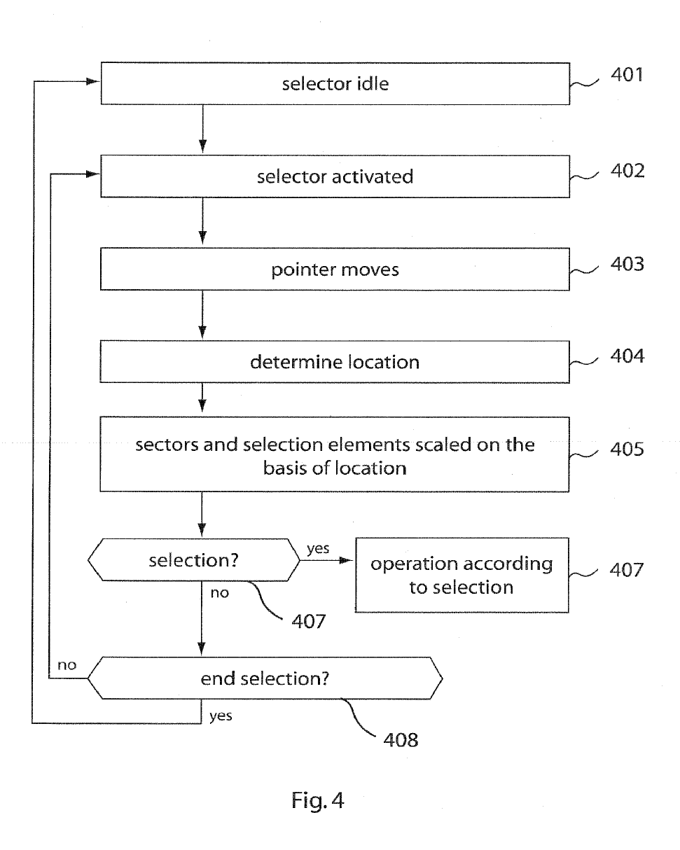

FIG. 4 is a flow chart illustrating the operation of an embodiment of the selector. The example of FIG. 4 starts from the idle mode (step 401), which is exited when it is detected that the pointer of the pointing means is activated (step 402). Activation is detected when, for example, the user starts selection. It is irrelevant to the invention as well as obvious to a person skilled in the art how the activation of the pointing means and pointer and their moving to a certain place are detected.

When the pointer moves (step 403), the pointer location on the selector is determined in step 404. It is irrelevant to the invention as well as obvious to a person skilled in the art how the movement of the pointer to a certain place is detected and how the location is determined. Selector sectors are scaled (step 405) simultaneously according to the location of the pointing means; for example, the sector is decreased in response to the receding of the pointing means and increased in response to the approaching of the pointing means the sector. Sectors are scaled according to a scaling algorithm so that the selector remains inside the area defined by a predetermined limit value or predetermined limit values. As the sector size changes, the size of the selection element is preferably also changed. In addition, the selector may highlight the selection element or selection elements towards which the pointing means moves or, for instance, change its/their colour.

If a selection element was selected after the moving (step 406), operation continues (step 407) according to the selected selection element and/or application for which the selector is used. For example, if text is to be typed in by the selector, the selected selection element is added to the text to be displayed on the screen, after which the idle mode, for example, is resumed. If, on the other hand, a program is to be started or the purpose is to move to a lower menu level having a selector of its own, movement to the lower selection level, which may include a selector of its own, takes place. If a player is concerned, it is possible to move to the beginning of the next piece, if the user has selected this option. It is, however, irrelevant to the invention how the selection is performed in practice and what will be done after the selection.

If no selection element was selected after moving (step 406) and selection was not finished but it continues, steps 403, 404 and 405 are repeated, i.e. the selector is scaled according to the pointer location each time the pointer moves. If selection was finished, the stylus, for example, no longer touches the control means and the selector returns to the idle mode (step 401).

The steps illustrated in FIG. 4 are not in an absolute chronological order and they may be performed in an order deviating from the given one or simultaneously. Some of the steps may also be omitted or replaced by definitions/settings performed on the device. Other functions may be carried out between the steps described or simultaneously with them. For example, when text is written, the element being selected, such as a letter, can be, in addition to the sector selector, presented as highlighted in the current location of the writing cursor before the actual selection takes place.

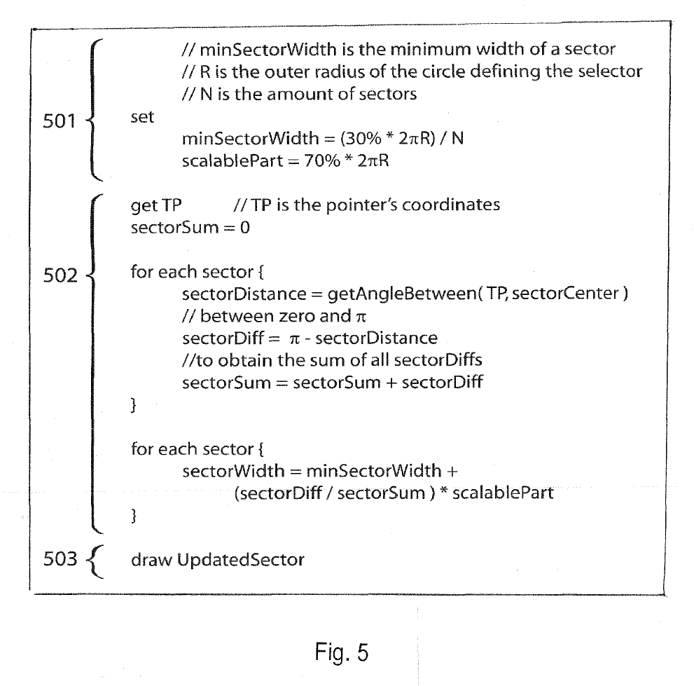

FIG. 5 illustrates a pseudo code of a scalability algorithm, which can be employed in a selector according to the invention, without limiting the invention to this algorithm. The example of FIG. 5 is a simple linear version where the pointer location on the screen is used as the input. The input is given as xy coordinates of a two-dimensional coordinate system, for example, and radians are used as the unit of angles. In this example, the distance means the distance as an angle; for example, the distance between the directions towards the right on the horizontal axis and upwards on the vertical axis is 90 degrees, i.e. π/2 as radians.

Part 501 of the pseudo code includes initial settings which prevent the sector from decreasing so that it disappears during the scaling. Part 502 of the pseudo code includes the actual algorithm which is used to calculate the size of each sector in relation to the pointer location, and part 503 includes updating the selector on the screen to correspond to the situation according to the pointer location. In the scaling algorithm 502 of FIG. 5, the centre angle of each sector is first compared to the selection point angle of the sector (sectorDistance), after which an inverse value is taken from it (sectorDiff) and used as the scaling factor of the sector concerned. This scaling factor is proportioned to the sum of the scaling factors of all sectors (sectorSum) so that the summed “width” or “angle” of the sectors fills the scaling area determined by the limit value. In this example, the scaling area is a full circle, where 70% are scaled and 30% constitute the minimum sector size.

Even though the circle radius was not scaled in the scaling algorithm described above but it remained constant, i.e. the screen surface area taken by the menu remained constant, it will be obvious to a person skilled in the art that the circle radius may also be modified in scaling. It is, however, advantageous to restrict the scaling area by limit values so that the whole menu stays within the screen area and part of it does not disappear, thus making it more difficult for the user to perceive the menu content.

Even though the invention was described above by examples where the device comprises only one selector, it will be obvious to a person skilled in the art that the device may comprise several different selectors, of which the most obvious one in view of the device use is employed (i.e. the selector or its sub-selector intended for the application) or a selector selected by the user. The selector may also be part of a hierarchic menu where one proceeds one level at a time so that the selector to be shown on the following screen is dependent on the selected sector of the previous selector. Furthermore, it will be obvious to a person skilled in the art that each selector may have a scaling algorithm of its own.

The device implementing the functionality according to the present invention comprises, in addition to the means needed in a prior art graphic user interface, such as display, control and processing means and optional pointers, means for scaling a sector including a selection element in response to the movement of the control means. More precisely, it comprises means for implementing at least one of the embodiments described above. Existing devices provided with a graphic user interface comprise processors and memory which may be utilized in the functions according to the invention. All changes and configurations needed to implement the invention may be performed as enhanced or updated software routines, by applications circuits (ASIC) and/or by otherwise configuring an existing device, in particular the graphic user interface. The software/software routine(s)/applets may be stored on any data storage means which is readable by the device or from which they are loadable into the device.

It will be obvious to a person skilled in the art that as technology advances, the inventive concept can be implemented in various ways. The invention and its embodiments are thus not limited to the examples described above but they may vary within the scope of the claims.

1. A method for manipulating a selector, which comprises one or more sectors or sector parts defined by at least two radii and a central angle between the two radii, the method comprising:
electronically detecting that the location of a selector pointer within a graphic user interface has changed; and,
updating the selector in response to a change of the pointer location by changing the central angle of one or more of the sectors or sector parts so that the selector remains in a scaling area defined by one or more predetermined limit values.

2. A method according to claim 1, wherein the updating comprises increasing the sector or sector part in response to the control means moving towards the sector, and decreasing the sector or sector part in response to the control means receding from the sector.

3. A method according to claim 1, wherein updating comprises modifying all sectors or sector parts related to the selector circumference or to a certain part of the circumference according to a predetermined algorithm.

4. A device which comprises;
a selector for selection by a user,
a graphic user interface for displaying the selector to the user, and
a control means for making a selection from the selector, the selector comprising one or more scalable sectors defined by at least two radii and a central angle between the two radii along with a selection element, wherein the device is configured to update the selector displayed on a screen by changing the central angle of one or more of the sectors or sector parts in response to a change in a pointer location so that the selector remains in a scaling area defined by one or more predetermined limit values.

5. A device according to claim 4, wherein the selector comprises at least two sectors or sector parts having the same centre, the device being configured to change the size of at least the two different sectors or sector parts upon updating.

6. A device according to claim 4, wherein the selector comprises at least one part which is based on a circumferential shape and has been divided into sectors.

7. A device according to claim 6, wherein the circumferential shape is a circle, triangle, rectangle, square, rhombus, semi-circle, ellipsis, hexagon or a corresponding geometric shape.

8. A device according to claim 4, wherein the sector size of the selector in an idle mode is determined according to the probability at which the selection element will be selected.

9. A computer software product which comprises a program stored on a program storage medium and readable by a device, characterized in that execution of the program on the device makes the device implement steps of the method according to claim 1.

10. A computer software product according to claim 9, which comprises at least one scaling algorithm for changing the size of a sector or sector part.

11. A method according to claim 2 wherein updating comprises modifying all sectors or sector parts related to the selector circumference or to a certain part of the circumference according to a predetermined algorithm.

12. A device according to claim 5 wherein the selector comprises at least one part which is based on a circumferential shape and has been divided into sectors.

13. A device according to claim 5 wherein the sector size of the selector in an idle mode is determined according to the probability at which the selection element will be selected.

14. A device according to claim 6 wherein the sector size of the selector in an idle mode is determined according to the probability at which the selection element will be selected.

15. A device according to claim 7 wherein the sector size of the selector in an idle mode is determined according to the probability at which the selection element will be selected.

16. A device according to claim 12 wherein the circumferential shape is a circle, triangle, rectangle, square, rhombus, semi-circle, ellipsis, hexagon or a corresponding geometric shape.

17. A device according to claim 12 wherein the sector size of the selector in an idle mode is determined according to the probability at which the selection element will be selected.

18. A method according to claim 1, wherein the selector is updated in response to a two dimensional, non-radial movement.
